(19) United States
(12) Patent Application Publication
(10) Pub. No.: US 2013/0212089 A1
(43) Pub. Date: Aug. 15, 2013

(54) Search Result Categorization

(71) Applicants: Scott M. Lederer, Brooklyn, NY (US); Jonathan C. Maslan, Burlingame, CA (US); Michelle I. Lee, Philadelphia, PA (US); Evelyn Kim, New York, NY (US); Bernhard A. M. Seefeld, New York, NY (US); Josh D. Mittleman, Croton On Hudson, NY (US)

(72) Inventors: Scott M. Lederer, Brooklyn, NY (US); Jonathan C. Maslan, Burlingame, CA (US); Michelle I. Lee, Philadelphia, PA (US); Evelyn Kim, New York, NY (US); Bernhard A. M. Seefeld, New York, NY (US); Josh D. Mittleman, Croton On Hudson, NY (US)

(73) Assignee: GOOGLE INC., Mountain View, CA (US)

(21) Appl. No.: 13/371,000

(22) Filed: Feb. 10, 2012

(51) Int. Cl. G06F 17/30

(52) U.S. Cl. 707/723; 707/722; 707/E17.091; 707/E17.075

(57) ABSTRACT

Methods, systems, and apparatus, including computer programs encoded on a computer storage medium, for receiving a search query; generating search results based on the search query; determining that a number of the search results is greater than a threshold; determining a category for each of the search results from among a plurality of categories; and transmitting the search results with instructions to display each of the search results based on its determined category.

### TECHNICAL FIELD

The present disclosure relates to displaying search results in response to a query, and more specifically, displaying categorized search results.

### BACKGROUND

Large volumes of information can be electronically accessed over networks such as the Internet. Searching services are used to identify particular information, such as web pages, media files, etc. that may be relevant to a user. Searching services can return search results in response to a search query, including hyperlinks to resources (e.g., web pages) that may be relevant to the search query. A goal of the searching service is to provide links to high quality, relevant search results to the user. However, the quality of the search results presented can be affected by the quality of the search query provided by the user.

In some circumstances, poorly crafted search queries can return a large number of search results that the user may find difficult to review and/or navigate to find relevant information. For example, the user can enter a search query that is more general than the actual subject matter for which the user is searching. In order to refine the search results, the user must construct and enter a more complex search query.

### SUMMARY

Innovative aspects of the subject matter described in this specification may be embodied in methods that include the actions of receiving a search query; generating search results based on the search query; determining that a number of the search results is greater than a threshold; determining a category for each of the search results from among a plurality of categories; and transmitting the search results with instructions to display each of the search results based on its determined category.

Other embodiments of these aspects include corresponding systems, apparatus, and computer programs, configured to perform the actions of the methods, encoded on computer storage devices.

These and other embodiments may each optionally include one or more of the following features. For instance, a first subset of the search results is determined to belong to a first one of the plurality of categories. A first one of the search results is determined to belong to two or more of the plurality of categories. Each of the categories in the plurality of categories include a category heading and displaying each of the search results beneath a category heading for its determined category. Ranking the search results in the first subset of search results that are determined to belong to a first one of the plurality of categories. A second subset of the search results is determined to belong to a second one of the plurality of categories, determining ranking scores for the first and second ones of the plurality of categories, and transmitting instructions to display the categories in an order based on their ranking scores. The ranking score of each of the first and second categories is based on the ranking scores of the search results respectively provided in each of the first and second categories. The categories include categories having a ranking score that is greater than a threshold ranking score. The categories include categories a second number of search results that is greater than a second threshold number. Determining the categories generated based on data associated with the search results. The categories are determined based on keywords extracted from the search results

Particular embodiments of the subject matter described in this specification may be implemented so as to realize one or more of the following advantages. For example, search results can be categorized to facilitate a user's ability to recognize the relevance of search results and to identify useful query refinements. Categorized search results lead the user to those query refinements that are best suited to identifying the information they are attempting to discover. Additional benefits of search results categorization is that it supports and encourages bundling of structured refinements (such as price level or opening hours) with qualitative, text-based refinements.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a diagram of an example system that can execute implementations of the present disclosure.

FIG. 2 depicts an example search results web page.

FIG. 3 depicts a block diagram of a system that includes example components for providing categorized search results.

FIG. 4 is a flowchart of an example process for providing search results.

Like reference symbols in the various drawings indicate like elements.

### DETAILED DESCRIPTION

This specification describes systems, methods, computer programs, and storage media for providing categorized search results to a user. Specifically, a user that is interested in a topic provides a search query to a searching service (e.g., Google Search) to gather more information concerning the topic. The searching service can generate a plurality of search results based on the search query. The searching service compares the number of the search results to a threshold, and when above the threshold, the searching service applies categories to the search results to generate categorized search results. The categorized search results are provided to the user. In some implementations, the searching service applies categories to the search results in view of other signals.

In some implementations, the categorized search results are obtained by clustering the search results according to one or more categories. For example, each resource (e.g., web page) underlying the search results can include an associated category. The category for a particular resource can be determined based on information related to the resource. To provide the categorized search results, the search results can be grouped based on category.

In some implementations, the search result categories can be generated prior to the user providing the search query to the searching service. In some examples, at least some of the resources can be organized into more than one category. In some implementations, generation of the search result categories can be done after the user provides the search query to the searching service, but before search results are provided to the user.

By way of non-limiting example, the user can be interested in hotels in the San Francisco area and can input the example search query “San Francisco hotels” into a search box of the searching service. In response to receiving the search query “San Francisco hotels,” the searching service generates search results including links to multiple web pages associated with hotels within the San Francisco area. In this example, the search results include thousands or more search results corresponding to hotels in the San Francisco area. To refine the search result, the searching service can organize the search results into search result categories when the number of search results is above a threshold. Specifically, the searching service categorizes (or clusters) the set of search results into search result categories, each of which includes a subset of the search results. Continuing with the above example, the searching service clusters the search results for hotels in San Francisco into search result categories such as boutique hotels, luxury hotels, cheap hotels, hotel spas, and other suitable categories. The searching service provides a subset of the search results organized according to the search result categories on a search results page. The presentation of search results organized according to search result categories, in addition to organizing the search results for the user, teaches the user different ways to refine queries for future search tasks.

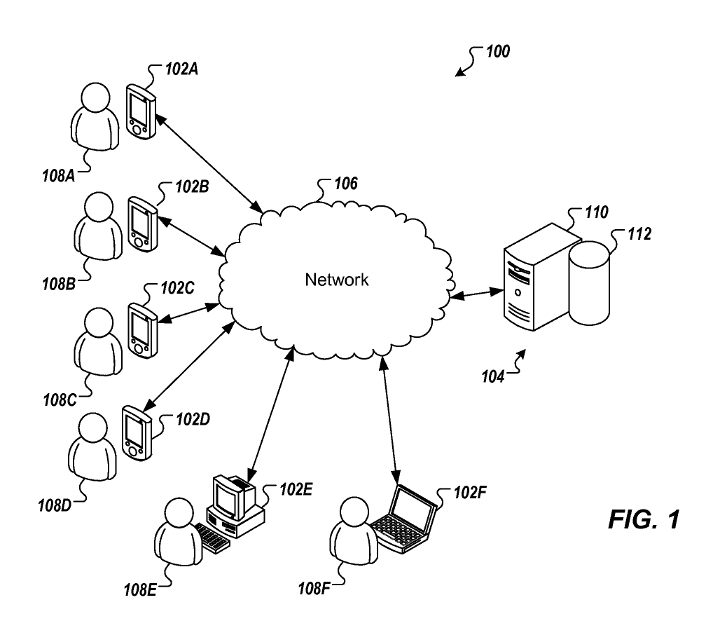

FIG. 1 is a diagram of an example system 100 that can execute implementations of the present disclosure. The system 100 includes computing devices 102A-102F that can each communicate with a server system 104 over a network 106. Each of the computing devices 102A-102F includes an associated user 108A-108F, respectively. The network 106 can include a large computer network, such as a local area network (LAN), a wide area network (WAN), the Internet, a cellular network, or a combination thereof connecting any number of mobile computing devices, fixed computing devices and server systems. The server system 104 includes one or more computing devices 110 and one or more machine-readable repositories, or databases 112.

In the example system 100, the computing devices 102A-102D are illustrated as mobile computing devices, the computing device 102E is illustrated as a desktop-type computing device and the computing device 102F is illustrated as a laptop-type computing device. It is appreciated, however, that the computing devices 102A-102F can each include any type of computing device such as a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices.

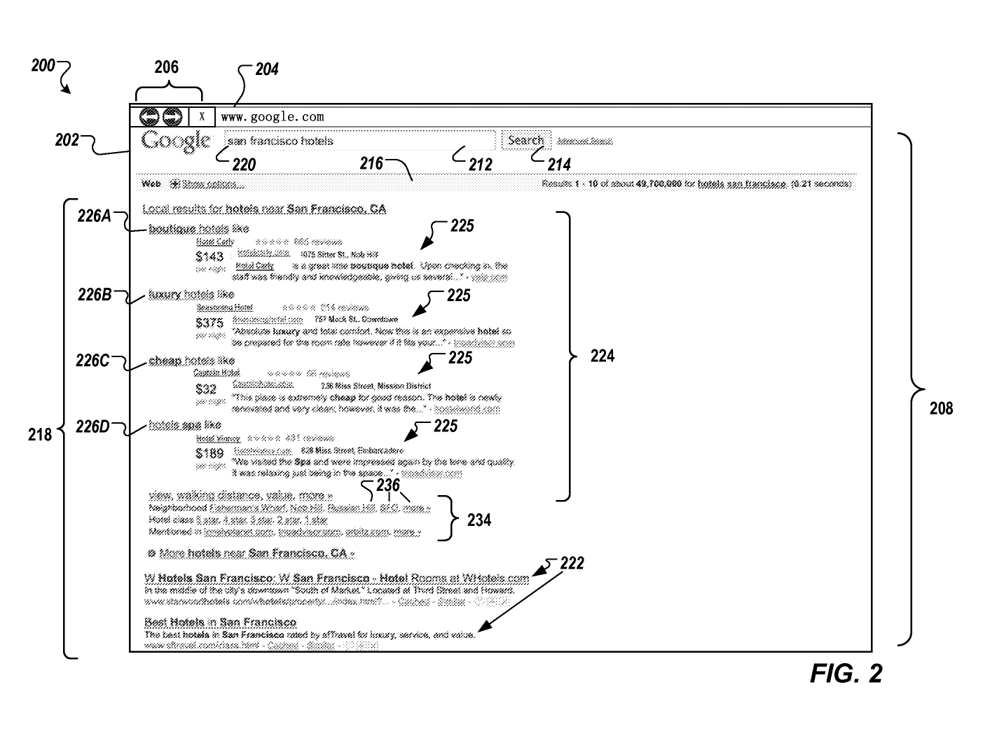

FIG. 2 depicts an example search results web page. Specifically, a GUI 200 displays an example search results page 202. The GUI 200 includes an address bar 204, navigation buttons 206, and a display region 208. The address bar 204 displays an Internet address of a web page currently being displayed by the GUI 202 in the display region 208. The navigation buttons 206 provide navigation between web pages (such as a “back” button to navigate to a previously viewed web page) and reloading or stop loading of a current web page, among other functionalities.

In the depicted example, the search results page 202 is provided by a searching service such as Google Search provided by Google Inc. The display region 208 displays the search results page 202 including a search query field 212, a search button 214, a results bar 216, and a search result list 218. A user (such as any user 108A-108F) that is interested in a topic enters a search query 220 relating to the topic into the search query field 212 to initiate a search. For example, the user is interested in hotels in the San Francisco area can input the search query 220 of “San Francisco hotels” into search query field 212. The searching service provides a search result list 218 that is responsive to the search query 220 on the search results page 202. The search result list 218 can include both search results 222 and a categorized search results list 224. The categorized search results list 224 can include categorized search results 225. The categorized search results list 224 includes search results 225 that are responsive to the search query 220 and that are categorized or clustered, as described further below.

In some examples, the categorized search results 225 are generated prior to delivering the search results to the user. Continuing with the example above, when the search query 220 is “San Francisco hotels,” the generated search results can be associated with multiple hotels within the San Francisco area (e.g., several hundreds or thousands of hotels in the San Francisco area). In some implementations, when the generated search results are greater than a threshold number of search results, the search results can be refined before being displayed to the user. In some implementations, the search results can be refined before being displayed to the user based on other signals, either in combination, or in lieu of, when the generated search results are greater than the threshold number of search results. For example, the signals can include provided input from the user, determined information based on the user (e.g., a user profile of the user), locale of the search query 220, the category of the search query 220, or any combination thereof.

When the signal includes input from the user, such input can include the user requesting categorized search results. In response, the search results can include categorized search results. When the signal includes information determined based on the user, the information can include, among other things, the search history of the user, geographic “check-in” history of the user (e.g., indicating the user has visited a geographic location), previously provided reviews of establishments (e.g., restaurants) by the user, or any combination thereof. For example, when a user provides the search query 220, the search results can be categorized into or more search result categories based on signals relating to the determined information of the user. Continuing the example above, the user 220 provides the search query 220 “San Francisco hotels.” The determined information based on the user can indicate the user is interested in luxury hotels based on the user's previously provided searches for luxury hotels, geographic “check-ins” at luxury hotels, and/or reviews provided regarding luxury hotels. The search results can be categorized into or more search result categories including a luxury hotels cateogry, described further below.

When the signal includes the locale of the search query 220, the locale can include a geographic region of the search query 220. For example, when a search query 220 includes a geographic region that would produce only a few search results (e.g., below a threshold), the associated signal can indicate such, and thus, the search results do not include categorized search results. However, when a search query 220 includes a geographic region that would produce many search results (e.g., above a threshold), the associated signal can indicate such, and thus, the search results include categorized search results. When the signal includes the category of the search query 220, the category can only have a few associated search results (e.g., below a threshold). Thus, the associated signal can indicate such, and thus, the search results do not include categorized search results. However, when the category includes multiple search results (e.g., above a threshold), the associated signal can indicate such, and thus, the search results include categorized search results.

In accordance with the present disclosure, the search results can be categorized (clustered) into one or more search result categories, and a categorized search results list (e.g., the categorized search results list 224) can be generated and displayed to the user based on the one or more categories. Each search result category displayed to the user can include one or more corresponding search results (e.g., search results 225). For example, as shown in FIG. 2, four search result categories 226A-226D are displayed to the user, and a single search result 225 is displayed under each category. The search result categories shown in FIG. 2 include a boutique hotels category (heading 226A), a luxury hotels category (heading 226B), a cheap hotels category (heading 222C), and a hotel spas category (heading 226D). In general, the categorized search result list 224 can include any number of search result categories.

The search result categories 226A-226D can be pre-determined based on previously obtained search results responsive to similar search queries previously submitted to the searching service. For example, the search system can obtain the pre-defined categories from the categories associated with the search results found to be responsive to the previously submitted and similar search queries. In some implementations, the search result categories can be determined from data obtained from review websites (e.g., Yelp, Google Places, Trip Advisor). Specifically, the review websites can include user-submitted reviews of establishments, for example, hotels in the San Francisco area. The reviews can include content describing the establishments, including keywords. The review websites can be mined for such keywords describing establishments, and the keywords can be used as search result categories.

In some implementations, the search result categories can have an associated ranking score (or quality score). In one implementation, the ranking score of a search result category can be based on the ranking scores of the search results that are classified into that category. The ranking scores for the search results can be determined by any suitable or known ranking algorithm. In some implementations, the search result categories 226A-226D are displayed in the search result list 224 in a ranked order. For example, the search result categories 226A-226D are displayed in a decreasing order of ranking score, and can alternatively be displayed in an increasing order of ranking score. In some implementations, the search result categories can be ranked by a number of search results that are classified into each search result category, such that the search result category with the larger number of search results appears higher (or lower) on the categorized search result list 224. In some implementations, only search result categories having a ranking score that is above a threshold are displayed in the categorized search result list 224.

In some implementations, the search results displayed within each search result category can be displayed in a ranked order, for example, in a decreasing order of ranking score. In some implementations, the number of search results displayed in each search result category can vary. For example, only one search result can be displayed per search result category, as depicted in FIG. 2, or two or more search results can be displayed per search result category in decreasing order of ranking score.

In some implementations, the headings 226A-226D can be selectable links (e.g., “clickable”). In these implementations, when one of the headings 226A-226D is selected, only search results that are categorized into that search result category are displayed to the user. In some implementations, the categorized search results list 224 includes only the search result categories 226A-226D, and does not include any search results 225. In some implementations, the search results listing 218 includes only the categorized search result list 224 and does not include search results 222.

In some implementations, the search results categories 226A-226D can further include an additional results link (not shown) that when selected, provides additional search results. For example, the search result category 226A can include an additional results link “show more luxury hotels,” (not shown) that when selected, displays additional search results relating to the “luxury” hotel category.

Further, the number of search result categories included in the categorized search result list 224 can vary depending on the search query 220. For example, for the search query 220 “hotels San Francisco,” four search result categories and associated headings 226 are provided in the categorized search result list 224. However, a different search query 220 can result in presentation of a different number of search result categories in the categorized search result list 224. Further, in some implementations, after presentation of the categorized search result list 224, the broader search results list 218 can include a “show more” link (e.g., “show more search result categories”) (not shown) to provide, when selected, additional search result categories responsive to the search query 220. For example, in addition to the search result categories 226A-226D, a “romantic” search result category (not shown) can also be included in the categorized search result list 224 when the “show more” link (not shown) is selected.

In some implementations, the search results list 218 can include one or more sorting selections 234. The sorting selections 234 are links that when selected, rank and/or sort the search results provided by the searching service by a different sorting and/or ranking criteria. For example, as depicted in FIG. 2, sorting selections 234 can include “view,” “walking distance,” “value,” “neighborhood,” “hotel class,” and “mentioned in,” and can be used to sort and/or rank the search results according to the quality of the view, walking distance from a given location, quality of neighborhood, etc. Furthermore, some sorting selections 234 can include further refinements of the search results. For example, for the sorting selection 234 “hotel class,” the sorting results 236 can be further refined to include “5 star,” “4 star,” “3 star,” “2 star,” and “1 star” hotels.

In some implementations, the categorized search results list 224 includes only search result categories that contain a number of search results above a threshold. In further implementations, search result categories that contain fewer search results than the threshold can be included in the categorized search results list 224 in response to a user selection to display such categories (e.g., via the “show more” link described above.)

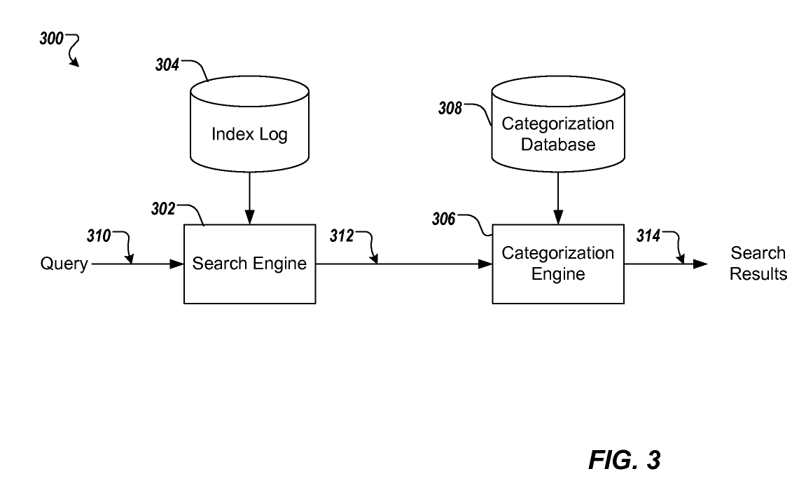

FIG. 3 depicts a block diagram of a system 300 that includes example components for providing categorized search results. In some examples, system 300 includes a search engine 302, an index log 304, a categorization engine 306, and a categorization database 308. The search engine 302 and the categorization engine 306 can each be provided as one or more computer programs that are executed using one or more computing devices (e.g., servers). The index log 304 and the categorization database 308 can be provided as one or more computer-readable storage media.

The search engine 302 receives a search query 310 (e.g., search query 220). In response to receiving the search query 310, the search engine 302 processes the search query 310 through one or more indices of the index log 304 to identify one or more search results.

The search results can be provided in a search results list 312. The index log 304 includes indexed information about resources available over a network (e.g., web pages available on the Internet). In some examples, the index log 304 includes an index of webpages whose content has been analyzed and indexed in view of various criteria (e.g., words extracted from titles, headings, or meta tags). In some implementations, the search engine 302 can determine the ranking score of the resources based on the search query 310 and other criteria (e.g., information known about a user, a “freshness” of the resources). In some implementations, the index log 304 includes previously determined ranking scores of the resources referenced in the index.

The categorization engine 306 receives the search result list 312 from the search engine 302 and compares the number of search results in the search results list 312 to a threshold. When the number of search results in the search result list 312 is above the threshold, the categorization engine 306 organizes the search results provided in the search result list 312 into one or more categories. In some examples, the categorization engine 306 organizes the search results of the search result list 312 in view of previously defined categories assigned to search results, which have been stored in the categorization database 308. For example, web pages can be previously analyzed and categorized based on their content, or based on their responsiveness to similar search queries that have been previously submitted. In some implementations, the categorization engine 306 organizes the search results provided in the search result list 312 based on other signals, either in combination, or in lieu of, when the number of search results in the search result list 312 is above the threshold. For example, the signals can include provided input from the user, determined info based on the user (e.g., a user profile of the user), locale of the search query 310, the category of the search query 310, or any combination thereof.

The categorization engine 306 applies the determined categories to the search results list 312 to provide a categorized search results list 314 (e.g., categorized search results list 224). In some implementations, the resources (e.g., the web pages) can be associated with more than one category (in the categorization database 308). When the number of search results of the search result list 312 is less than the threshold, the categorized engine 306 does not organize the search results provided in the search result list 312 into categories and provides (i.e., passes along) the search results list 312.

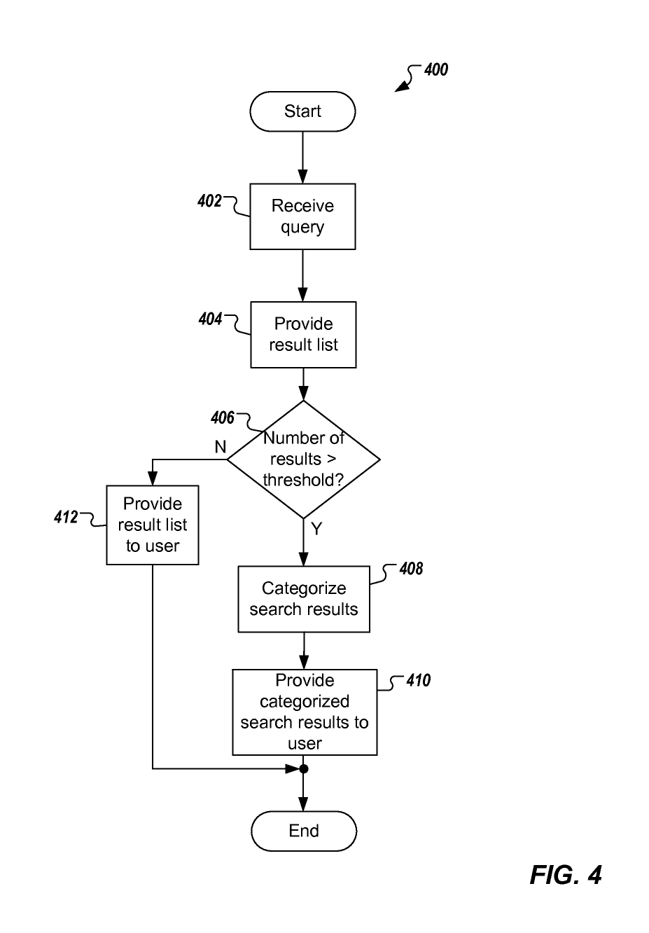

FIG. 4 is a flowchart of an example process 400 for providing search results. The example process 400 can be executed using one or more computing devices. For example, the computing devices 102 and/or the server system 104 employing the system 300 of FIG. 3 can be used to execute the example process 400.

A search query is received (402). For example, the search query can be the search query 220, received as input to the search query field 212. Further, the search query can be the search query 310 that is provided to (i.e., received by) the search results engine 304. A search results list is provided (404). For example, the search results list can be the search result list 218 provided in response to the search query 220, or the search results list 312 provided by the search results engine 302 in response to the search query 310.

The number of search results of the search results list is compared to a threshold (406), for example, by the categorization engine 306. When the number of search results of the search result list is greater than or equal to the threshold, the search results are categorized (408). For example, when the number of search results of the search result list 312 is above the threshold, the categorization engine 306 organizes the search results into one or more categories. In response to categorizing the search results, a categorized search results list is provided (410). For example, the categorization engine 306 provides the categorized search results list 314.

When the number of search results of the search result list is less than the threshold, the search results list is provided without categorization (412). For example, when the number of search results of the search result list 312 is less than the threshold, the categorization engine 306 does not organize the search results provided in the search result list 312 into any categories.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the present disclosure can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this present disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A system comprising:
one or more computers; and
one or more computer-readable mediums coupled to the one or more computers having instructions stored thereon which, when executed by the one or more computers, cause the one or more computers to perform operations comprising:
receiving a search query;
generating search results based on the search query;
determining a category for each of the search results from among a plurality of categories when the number of the search results is greater than a threshold;
scoring the categories for the search results;
identifying a subset of the categories having a score that is above a threshold score; and
transmitting the search results with instructions to display each category of the subset of categories with search results that correspond to the category.

2. The system of claim 1, wherein a first subset of the search results is determined to belong to a first one of the plurality of categories.

3. The system of claim 1, wherein a first one of the search results is determined to belong to two or more of the plurality of categories.

4. The system of claim 1, wherein the instructions to display each category of the subset of categories with search results that correspond to the category comprise instructions to display each of the search results beneath a category heading for its determined category.

5. The system of claim 2, wherein the one or more computers further perform operations comprising ranking the search results in the first subset of search results that are determined to belong to a first one of the plurality of categories.

6. The system of claim 1, wherein the instructions to display each category of the subset of categories with search results that correspond to the category comprise instructions to display the categories in an order based on their scores.

7. The system of claim 6, further comprising determining a ranking score for each of the search results, wherein the score of each of the categories is based on the ranking scores of the search results respectively provided in each of the categories.

8. (canceled)

9. The system of claim 1, wherein the categories include a number of search results that is greater than a threshold number of search results.

10. The system of claim 1, wherein the categories are determined based on data associated with the search results.

11. The system of claim 10, wherein the categories are determined based on keywords extracted from the search results.

12. A computer-implemented method comprising:
receiving a search query from a client device;
generating search results based on the search query;
identifying a plurality of categories responsive to the search query when the number of the search results is greater than a threshold, wherein each search result is associated with at least one of the plurality of categories;
scoring the categories for the search results;
identifying a subset of the categories having a score that is above a threshold score; and
transmitting the search results and the subset of categories to the client device with instructions to display each category of the subset of categories with search results that correspond to the category.

13. The method of claim 12, wherein identifying the plurality of categories responsive to the search query further comprises identifying categories that are associated with more than a threshold number of search results.

14. The method of claim 12, wherein identifying the plurality of categories responsive to the search query further comprises identifying categories that have been assigned to the search results that are responsive to the search query.

15. The method of claim 12, wherein identifying the plurality of categories responsive to the search query further comprises identifying categories that have been assigned to documents found to be responsive to a previous search query that is similar to the received search query.

16. The method of claim 12, wherein identifying the plurality of categories responsive to the search query further comprises identifying categories from keywords associated with documents found to be responsive to a previous search query that is similar to the received search query.

17. The method of claim 12, further comprising:
ranking the search results within each of the plurality of categories, and transmitting instructions to display the search results within each of the respective categories according to rank.

18. The method of claim 17, further comprising:
ranking each of the plurality of categories based on the ranking of the search results respectively associated with each of the plurality of categories; and
transmitting instructions to display the subset of categories according to rank.

19. The method of claim 18, wherein transmitting the search results and the subset of categories to the client device further comprises limiting the plurality of transmitted categories to those categories having a rank that exceeds a threshold.

20. The method of claim 12, further comprising limiting the number of search results displayed per category to a number less than a threshold.

21. The method of claim 12, further comprising limiting the number of categories to a number less than a threshold.

22. A system comprising:
one or more computers; and
one or more computer-readable mediums coupled to the one or more computers having instructions stored thereon which, when executed by the one or more computers, cause the one or more computers to perform operations comprising:
receiving a search query from a client device;
generating a number of search results based on the search query;
determining a category for each of the search results when the number of the search results is greater than a threshold; and
providing the search results to the client device as a non-categorized ranked list when the number of search results is less than a threshold, and as a categorized ranked list when the number of search results is greater than the threshold.

23. A system comprising:
one or more computers; and
one or more computer-readable mediums coupled to the one or more computers having instructions stored thereon which, when executed by the one or more computers, cause the one or more computers to perform operations comprising:
receiving a search query from a user of a client device;
generating a number of search results based on the search query;
categorizing the search results into one or more categories based on user information; and
providing the categorized search results to the client device.

24. The system of claim 23, wherein the user information includes user check-in information.
